(19) United States
(12) Patent Application Publication
(10) Pub. No.: US 2024/0295209 A1
(43) Pub. Date: Sep. 5, 2024

(54) WIND TURBINE ROTOR BLADE WITH PASSIVE AIRFLOW MODIFYING ASSEMBLY

(71) Applicants: Peter Daniel SILKOWSKI, Niskayuna, NY (US); LM Wind Power A/S, Kolding (DK)

(72) Inventor: Peter Daniel Silkowski, Scotia, NY (US)

(21) Appl. No.: 18/578,427

(22) PCT Filed: Jul. 16, 2021
(86) PCT No.: PCT/US2021/041970

§ 371 Date: Jan. 11, 2024

(51) Int. Cl. F03D 1/06; F03D 7/02

(52) U.S. Cl. CPC F03D 1/0675; F03D 7/022; F05B 2240/303; F05B 2240/304; F05B 2240/305; F05B 2240/307

(57) ABSTRACT

The present disclosure is directed to a rotor blade having a passive airflow modifying assembly to create an airflow feature along the blade, based on the instant pressure gradient around the blade during operation. The present disclosure also is directed to a rotor blade that passively channels airflow through the passive airflow modifying assembly to create an air feature that decreases the aerodynamic load, at times when the aerodynamic load experienced by the blade is bearing on the rotatable hub, and one the passively channels airflow through the passive airflow modifying assembly to create an air feature that increases the aerodynamic load, at times when the aerodynamic load is not bearing on the rotatable hub, and one that passively operates to not create an air feature, at times when the requisite pressure gradient is not met and/or when the load conditions are not an issue.

### FIELD

The present disclosure generally relates to wind turbines, and more particularly, to a wind turbine rotor blade having a passive airflow modifying assembly that reacts as a function of the changing pressure gradients along, and the angle-of-attack (AoA) conditions of, the revolving rotor blade.

### BACKGROUND

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy from wind using known airfoil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

The particular size of a wind turbine rotor blade is a significant factor contributing to the overall efficiency of the wind turbine. Specifically, increases in the length or span of a rotor blade may generally lead to an overall increase in the energy production of a wind turbine. Accordingly, efforts to increase the size of rotor blades aid in the continuing growth of wind turbine technology and the adoption of wind energy as an alternative energy source. However, as rotor blade sizes increase, so to do the loads transferred through the rotor blades to the other components of the wind turbine (e.g., the wind turbine rotatable hub and other components). Further, consideration must be given to the fact that load-transfer is variable during each revolution of a rotor blade about the turbine shaft—as each rotor blade experiences a dynamic set of pressure gradients and AoAs during a single revolution.

For example, the magnitude of deflection forces and loading of a rotor blade is generally a function of the rotor blade length, wind speed, turbine operating states, blade stiffness, pressure gradient, AoA, and/or other variables. Longer rotor blades result in higher loads due to the increased mass of the rotor blades, as well as the increased aerodynamic loads acting along the span of the blade. Such increased and variable loads can be particularly problematic in high-speed wind conditions, as the loads transferred from the rotor blades may exceed the load-bearing capabilities of the other wind turbine components.

Load control is thus a crucial consideration in operation of modern wind turbines. Besides active pitch control systems, it is also known in the art to vary the aerodynamic characteristics of the individual rotor blades as a means of load control, e.g., with controllable vortex elements, flaps, tabs, spoilers, and the like configured on the rotor blade surfaces.

Certain surface features, such as spoilers, are known that may be utilized to separate the flow of air from the outer surface of a rotor blade, thereby reducing the lift generated by the rotor blade and reducing the aerodynamic loads acting thereon. However, these surface features are typically designed to be permanently disposed along the outer surface of the rotor blade. As such, the amount of lift generated by the rotor blade is reduced regardless of the conditions in which the wind turbine is operating.

Still other rotor blades may include actuators for manipulating the surface features between an active and non-active configuration. However, such systems add complexities, weight, and/or additional costs to the rotor blade.

Accordingly, the industry would benefit from a wind turbine rotor blade that facilitates load control yet avoids the expense of—and the relatively complicated components associated with—an active management system that relies on significant structural or physical modifications to the rotor blade.

### BRIEF DESCRIPTION

Aspects and advantages of the disclosure will be set forth in part in the following description, or may be obvious from the description, or may be learned through practice of the disclosure.

In an aspect, the present disclosure is directed to a rotor blade assembly of a wind turbine. The rotor blade assembly includes a rotor blade extending between a blade root and a blade tip. The rotor blade has surfaces defining a suction side surface, a pressure side surface, a leading edge, and a trailing edge. The surfaces are arranged together to define an aerodynamic shell or an interior region. The rotor blade assembly also includes a passive airflow modifying assembly arranged between one or more of the surfaces or within the interior region. The passive airflow modifying assembly has a plurality of internal air passages for channeling airflow, wherein each of the plurality of internal air passages extends from a common junction within the interior region or between the one or more of the surfaces to one of a plurality of apertures defined by the aerodynamic shell. The plurality of internal air passages passively channel airflow from different locations on the surfaces based on a pressure gradient around the aerodynamic shell to create an airflow feature at another location on at least one of the surfaces, thereby altering the pressure gradient.

In another aspect, the present disclosure is directed to a wind turbine including a tower, a nacelle mounted atop the tower, and a rotor having a rotatable hub coupled to the nacelle. The rotatable hub includes at least one rotor blade assembly extending outwardly therefrom. The rotor blade assembly includes a rotor blade having a root portion for engaging with the rotatable hub and an airfoil portion extending from the root portion and experiencing an aerodynamic load. The root portion and the airfoil portion define an interior region. The rotor blade assembly also includes a passive airflow modifying assembly within the interior region. The passive airflow modifying assembly includes a plurality of internal air passages for channeling airflow, wherein each of the plurality of internal air passages extends from a common junction within the interior region to one of a plurality of apertures defined by the airfoil portion. The plurality of internal air passages passively channel the airflow between the plurality of apertures based on a pressure gradient surrounding the rotor blade—to create a variable airflow feature along the airfoil portion of the rotor blade—thereby affecting the aerodynamic load experienced by the rotor blade. Each of the plurality of apertures is configured to reversibly switch from being an air inlet to an air outlet based on the direction of the pressure gradient.

In another aspect, the present disclosure is directed to a method of passively modifying a pressure gradient surrounding a rotor blade of a wind turbine during operation thereof. The method includes providing a rotor blade extending between a blade root and a blade tip and having surfaces defining a suction side surface, a pressure side, a leading edge, and a trailing edge. The surfaces are arranged together to define an aerodynamic shell and the aerodynamic shell is configured to experience an aerodynamic load. The method also includes providing a plurality of internal air passages within an interior region of a rotor blade having an airfoil portion. The airfoil portion has a leading edge and a trailing edge and defines the interior region of the rotor blade. Each of the plurality of internal air passages extends from a common junction within the interior region to one of a plurality of apertures on one of the surfaces of the rotor blade. The method also includes allowing the rotor blade to rotate about a rotatable hub of the wind turbine such that the rotor blade experiences a pressure gradient. The method also includes passively channeling airflow through the plurality of internal air passages between the plurality of apertures based on the pressure gradient to create an airflow feature at another one of the plurality of apertures on one of the surfaces of the rotor blade, thereby altering the pressure gradient.

These and other features, aspects and advantages of the present disclosure will become better understood with reference to the following description and appended claims. The accompanying drawings, which are incorporated in and constitute a part of this specification, illustrate embodiments of the disclosure and, together with the description, explain the principles of the disclosure.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of an embodiment of a wind turbine according to the present disclosure;

FIG. 2 illustrates a perspective view of an embodiment of a rotor blade having a passive airflow modifying assembly according to the present disclosure;

FIG. 3 illustrates a cross-sectional view of the rotor blade of FIG. 2 taken along the sectional line A-A according to the present disclosure;

FIG. 4 illustrates a cross-sectional view of another embodiment of a rotor blade having a passive airflow modifying assembly according to the present disclosure;

FIG. 5 illustrates a partial, perspective view of another embodiment of a rotor blade having a passive airflow modifying assembly according to the present disclosure;

FIG. 6A illustrates a detailed cross-sectional view of another embodiment of a rotor blade having a passive airflow modifying assembly in an elevated configuration according to the present disclosure;

FIG. 6B illustrates a detailed cross-sectional view of the rotor blade of FIG. 6A having a passive airflow modifying assembly in a retracted configuration according to the present disclosure;

FIG. 7 illustrates a cross-sectional view of another embodiment of a rotor blade according to the present disclosure, particularly illustrating the instant pressure gradient about the rotor blade;

FIG. 8A illustrates a cross-sectional view of another embodiment of a rotor blade according to the present disclosure, particularly illustrating the instant pressure gradient about the rotor blade as the rotor blade is exposed to a first flow angle;

FIG. 8B illustrates a cross-sectional view of another embodiment of a rotor blade according to the present disclosure, particularly illustrating the instant pressure gradient about the rotor blade as the rotor blade is exposed to a second flow angle;

FIG. 9A illustrates a cross-sectional view of the rotor blade of FIG. 8A having an air feature being expelled from the suction side according to the present disclosure, particularly illustrating the instant pressure gradient about the rotor blade;

FIG. 9B illustrates a cross-sectional view of the rotor blade of FIG. 8B having an air feature being expelled from the pressure side according to the present disclosure, particularly illustrating the instant pressure gradient about the rotor blade;

FIG. 10 illustrates a flow diagram of an embodiment of a method passively modifying a pressure gradient surrounding a rotor blade of a wind turbine during operation thereof according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

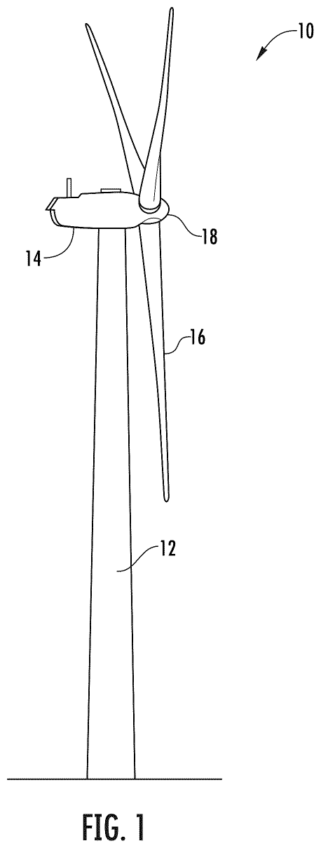

Referring now to the drawings, FIG. 1 illustrates a perspective view of an exemplary embodiment of a wind turbine 10 according to the present disclosure. As shown, the wind turbine 10 is a vertical-axis turbine, but in other embodiments the wind turbine 10 may be a horizontal axis turbine. The wind turbine 10 includes a tower 12—supported on a base foundation—with a nacelle 14 mounted thereon. A plurality of rotor blades 16 are mounted to a rotatable hub 18, which is, in turn, connected to a main flange that turns a main rotor shaft (not illustrated). The plurality of rotor blades 16 are coupled to and extend radially outward from the rotatable hub 18. The wind turbine power generation and control components are housed within the nacelle 14 and communicatively coupled to the main rotor shaft.

It should be appreciated that the view of FIG. 1 is provided for illustrative purposes only, and to place the present subject matter in an exemplary field of use. A person having ordinary skill in the art readily appreciates that the present disclosure is not limited to any one type of wind turbine configuration.

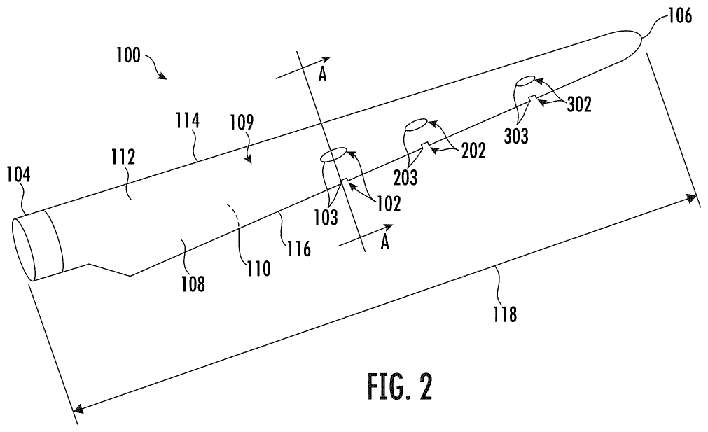

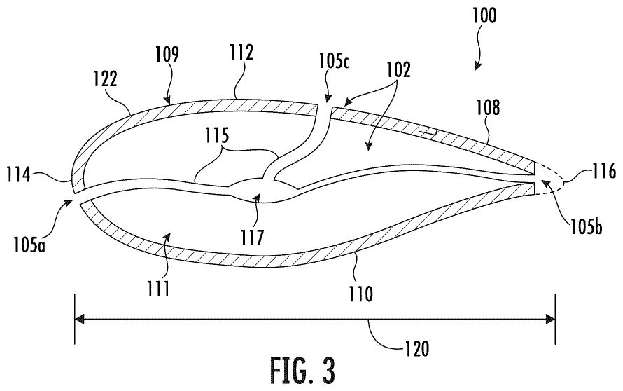

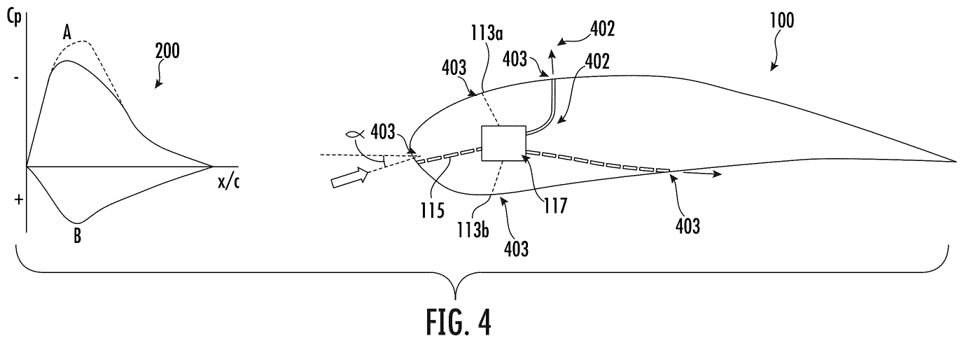

Referring now to FIGS. 2-4, various views of an exemplary embodiment of a rotor blade assembly 100 of the wind turbine 10 are illustrated. As shown the rotor blade assembly 100 may correspond to any of the rotor blades 16 illustrated in FIG. 1. Further, as illustrated, the rotor blade assembly 100 has a at least one passive airflow modifying assembly 102 in accordance with the aspects of the present disclosure. In particular, FIG. 2 illustrates a perspective view of the rotor blade assembly 100 having a passive airflow modifying assemblies 102, 202, 302 spaced apart thereon. FIG. 3 illustrates a cross-sectional view of another exemplary embodiment of a rotor blade assembly 100 shown in FIG. 2 taken along the sectional line A-A. FIG. 4 illustrates a cross-sectional view of another exemplary embodiment of a rotor blade assembly 100 having a passive airflow modifying assembly 102 in accordance with the aspects of the present disclosure.

In the embodiment of FIGS. 1-4, the rotor blade assembly 100 includes a blade root 104 configured for mounting the rotor blade assembly 100 to the rotatable hub 18 of the wind turbine 10 (FIG. 1), and a blade tip 106 disposed opposite the blade root 104. An aerodynamic shell 108 extends between the blade root 104 and the blade tip 106. External surfaces define the shell 108. In certain embodiments, the shell 108 is defined by various external surfaces and operates as the outer casing/covering of the rotor blade assembly 100. Thus, the shell 108 defines an airfoil portion 109 of the rotor blade assembly 100. Further, the rotor blade assembly 100 has a span 118 defining the total length between the blade root 104 and the blade tip 106, and a chord 120 defining the total length between a leading edge 114 and a trailing edge 116. As is generally understood, the chord 120 usually varies in length with respect to the span 118, as the rotor blade assembly 100 extends from the blade root 104 to the blade tip 106. Thus, one of ordinary skill in the art appreciates that the “chord-wise direction” refers to a direction extending parallel to the chord 120 of the rotor blade assembly 100, and that the “span-wise direction” refers to the direction extending parallel to the span 118 of the rotor blade assembly 100.

Referring particularly to FIG. 3, the shell 108 defines the airfoil portion 109, which includes a pressure side surface 110 and a suction side surface 112, each extending between the leading edge 114 and the trailing edge 116. Further, as illustrated in FIG. 3, the shell 108 defines the internal region 111. The shell 108 may be formed as a single, unitary component. Alternatively, the shell 108 may be formed from a plurality of shell components. For example, the shell 108 may be manufactured from a first shell half generally defining the pressure side surface 110 and a second shell half generally defining the suction side surface 112, with the shell halves being secured to one another at the leading edge 114 and the trailing edges 116.

Additionally, the shell 108 may be formed from any suitable material, and/or from any method of manufacture, e.g., molding, multi-layer construction, and additive manufacturing. For example, the shell 108 may be formed entirely from a laminate composite material, such as a carbon fiber reinforced laminate composite, or a glass fiber reinforced laminate composite. Alternatively, one or more portions of the shell 108 may be configured as a layered construction and may include a core material, formed from a lightweight material such as wood (e.g., balsa), foam (e.g., extruded polystyrene foam) or a combination of such materials, disposed between layers of laminate composite material.

Additive manufacturing or 3-D printing, as used herein, is generally understood to encompass processes used to synthesize three-dimensional objects in which successive layers of material are formed under computer control to create the objects. Objects of almost any size and/or shape can be produced from digital model data. It should further be understood that the methods of the present disclosure are not limited to additive manufacturing, but rather, may also encompass more than three degrees of freedom such that the printing techniques are not limited to printing stacked two-dimensional layers, but are also capable of printing curved shapes.

In particular embodiments, for example, additive manufacturing may include, metal wire transfer, electron beam melting, inertial welding, powder nozzle laser deposition, directed energy deposition, binder jetting, material jetting, laser cladding, cold spray deposition, directed energy deposition, powder bed fusion, material extrusion, direct metal laser sintering, direct metal laser melting, cold metal transfer, metal inert gas (MIG) welding, tungsten inert gas (TIG) welding, vat photopolymerisation, or any other suitable additive manufacturing process.

It should be appreciated that the rotor blade assembly 100 of FIG. 3 may also include one or more internal structural components at least partially disposed within the internal region 111. For example, the rotor blade assembly 100 may include one or more shear webs (not illustrated) extending between corresponding spar caps (not illustrated). The rotor blade assembly 100 also may include mechanical actuators and/or electric motor, etc. (not illustrated) within the internal region 111.

Still referring to FIGS. 1-4, the rotor blade assembly 100 includes one or more passive airflow modifying assembly(s) (“PAMA”) 102 to create an airflow feature along the airfoil portion 109 (for example, along the pressure side surface 110 and/or the suction side surface 112 of the rotor blade assembly 100), based on the pressure gradient around the rotor blade assembly 100 at any specific instance during operation. In particular, and in one exemplary embodiment, the PAMA 102 is configured to reversibly switch the direction of airflow through and out of the PAMA 102 based on the instant pressure gradient between one or more air inlet(s) and/or the air outlet(s) for the PAMA 102. The result is a variable airflow feature that: (1) manifests along the airfoil portion 109—depending on where and how the air inlet and the air outlet of the PAMA 102 are situated and configured—and that (2) also passively switches positions along the airfoil portion 109—depending on the instant pressure gradient around the rotor blade assembly 100 during operation in real-world conditions.

It should be apparent that, as the rotor blade assembly 100 operates in real-world conditions, and as it extends from and revolves about the rotatable hub 18, the pressure gradient around the rotor blade assembly 100 is variable as a function of a variety of factors including the instant pitch of the rotor blade assembly 100, the instant AoAs experienced by the rotor blade assembly 100, the instant location of the rotor blade assembly 100 around the rotatable hub 18, and/or the instant wind and weather conditions, etc. As such, the aerodynamic load transferred through the rotor blade assembly 100 to the rotatable hub 18, and bearing on the rotor in general, also is variable—due to the changing pressure gradient conditions and the resulting positive or negative lift forces experienced by the rotor blade assembly 100 at any point in time during a revolution.

Therefore, aspects of the present disclosure leverage these circumstances to yield a rotor blade assembly 100 that—at times when the aerodynamic load is bearing on the rotatable hub 18—passively channels airflow through the PAMA 102 to create an air feature that decreases the aerodynamic load. Similarly, aspects of the present disclosure also yield a rotor blade assembly 100 that—at times when the aerodynamic load is not bearing on the rotatable hub 18—passively channels airflow through the PAMA 102 to create an air feature that increases the aerodynamic load. In addition, aspects of the present disclosure also yield a rotor blade assembly 100 that—at times when the requisite pressure gradient is not met and/or when the load conditions are not an issue, passively operates to not create an air feature, so as to not affect the standard performance and/or efficiency of the rotor blade assembly 100. Accordingly, the rotor blade assembly 100 of the present disclosure reduces the dynamic loads on the wind turbine 10 and does not require mechanical actuators, sensors, pumps, actively managed air inlets or air outlets, or any other actively controlled system to make the PAMA 102 properly function in real-time and in real-world conditions.

In general, the rotor blade assembly 100 may be configured to include any number of PAMAs 102. In the embodiment illustrated in FIGS. 1-3, the rotor blade assembly 100 includes the PAMA 102, 202, 302 spaced span-wise apart along the shell 108, each having a plurality of internal air passages 115 each of which extends from a common junction 117 within the interior region 111 to a different location on one of the pressure side surface 110 or the suction side surface 112. PAMA 202 and 302 are essentially identical to PAMA 102. The plurality of internal air passages 115 are configured to passively channel airflow from the different locations on at least one of the pressure side surface 110 or the suction side surface 112, to create an airflow feature (not illustrated) at another location on at least one of the pressure side surface 110 or the suction side surface 112. However, in alternative embodiments, the rotor blade assembly 100 may include fewer than three PAMA, such as one PAMA or two PAMA, or greater than three PAMA, such as four PAMA, five PAMA or more than five PAMA. Further, each PAMA 102, 202, 302, may be differently configured and/or tuned for its respective plurality of internal air passages 115 and common junction 117 and intended airflow features, for example.

Additionally, each PAMA 102, 202, 302, may have a plurality of apertures 103 defined by the airfoil portion 109—corresponding to the plurality of internal air passages 115—and situated at anywhere on the airfoil portion 109, including the blade tip 106, the leading edge 114, and the trailing edge 116, and anywhere in between, on either the pressure side surface 110 or the suction side surface 112 of the shell 108. In the embodiment of FIGS. 1-3, the PAMA 102 has an aperture 105a, an aperture 105b, and an aperture 105c, each spaced chord-wise apart along the shell 108, each in fluid communication with an internal air passage of the plurality of air passages 115 within the interior region 111. The plurality of apertures 103 are configured to passively, reversibly switch from being an air inlet to an air outlet for the PAMA 102—based on the direction of the airflow through the plurality of internal air passages 115 and the common junction 117—to create an airflow feature (not illustrated) at the air outlet, at either the pressure side surface 110 or the suction side surface 112, based on the pressure gradient between the air inlet and the air outlet.

However, in alternative embodiments, the PAMA 102 may have a plurality of apertures 103 also spaced span-wise along the shell 108, and possibly having a corresponding chord-wise spacing or no chord-wise spacing. The PAMA 102 may include fewer than three individual apertures 105a,b,c, such as two apertures 105a,bor greater than three apertures 105a,b,c, such as four apertures 105a,b,c,d or five apertures 105a,b,c,d,e or more than five apertures 105a,b,c,d,e. Each aperture 105 may be differently sized, shaped, and configured for its respective internal air passage of the plurality of internal air passages 115, for example. The individual apertures 105 of the plurality of apertures 103 may have sub-apertures, a multi-part opening, a grate, etc. functioning as an individual aperture 105, and the individual apertures 105 may in some instances operate as a control port or diagnostic access point for the plurality of internal air passages 115 and/or the common junction 117 and/or the interior region 111.

For instance, as is illustrated in FIG. 3, the aperture 105a is situated on or adjacent to the leading edge 114, and the aperture 105b is situated on or adjacent to the trailing edge 116—on either the pressure side surface 110 or the suction side surface 112 of the shell 108. The aperture 105c is situated on one exemplary location on the suction side surface 112. The plurality of apertures 103 are aligned span-wise but are spaced out chord-wise at disparate locations along the shell 108. The aperture 105a, the aperture 105b, and the aperture 105c allow airflow into or out of the plurality of air passages 115 and the common junction 117 within the interior region 111. The aperture 105a, the aperture 105b, and the aperture 105c are, respectively, configured to passively, reversibly switch from being an air inlet to an air outlet—based on the instant direction of the airflow through the PAMA 102—to create an airflow feature (or not) at either the pressure side surface 110 or the suction side surface 112. Whether the airflow features on either the pressure side surface 110 or the suction side surface 112, via the aperture 105b and the aperture 105c respectively, are created (or not) is based on the instant pressure gradient between the plurality of apertures 103.

For example, in an embodiment, if the instant pressure gradient between the aperture 105a, the aperture 105b, and the aperture 105c passively exceeds a first pressure-differential threshold for which the PAMA 102 is specifically tuned, then the PAMA 102 passively channels airflow at least through the aperture 105a and out at least through the aperture 105c. This creates a fence of air along the suction side surface 112 and adjacent to the aperture 105c to separate the air flowing over the outer surface 122 of the shell 108. Similarly, if the instant pressure gradient between the aperture 105a, the aperture 105b, and the aperture 105c passively exceeds a second pressure-differential threshold for which the PAMA 102 is specifically tuned, then the PAMA 102 passively channels airflow at least through the aperture 105a and out at least through the aperture 105b. This creates an air-jet blowing out of the pressure side surface 110 from the aperture 105b. If neither the first nor the second pressure-differential thresholds are exceeded, then no airflow feature is created. As such, the PAMA 102 is configured to apply fluidics to create a rotor blade that passively switches between air-jets to either decrease (“spoil”) or increase (“augment”) the aerodynamic loads experienced by the rotor blade assembly 100 in a manner that reduces the overall load variations experienced by the rotatable hub 18.

In other embodiments of the PAMA 102, the pressure-differential threshold(s) to activate/deactivate the same or different airflow features along the airfoil portion 109 are tuned based on a variety of factors affecting the fluid-dynamic profile of the PAMA 102, e.g., the location, size, shape, configuration of the apertures 105a,b,c and the relative distance and spacing between them, and the length, width, girth, configuration of the plurality of air passages 115 and the common junction 117, and the aerodynamic profile and features of the rotor blade assembly 100. As such, the PAMA 102 is configured to passively, reversibly switch the direction of airflow through and out of the PAMA 102 based on the relevant instant pressure gradients and the specific tuning of the PAMA 102, resulting in activating/deactivating a variable airflow feature(s).

Referring again to FIG. 4, a cross-sectional view of another embodiment of a rotor blade assembly 100 is illustrated, particularly illustrating the PAMA 402. The cross-sectional view reveals the PAMA 402 alongside a corresponding aerodynamic load diagram 200, wherein load is as a function of operating time (or a rotor blade's revolution about the rotatable hub 18). More specifically, as shown, the rotor blade 100 includes the PAMA 402. In contrast to PAMA 102 of FIGS. 1-3, however, the PAMA 402 of FIG. 4 has: (1) a plurality of apertures 403 including a control port 113a on the suction side surface 112 and a control port 113b on the pressure side surface 110 of the shell 108; (2) a plurality of air passages 115 corresponding to the plurality of apertures 403; and (3) a common junction 117 configured and tuned entirely as a passive fluidic chamber or conduit or having some passive mechanical features such as a spring-resistance flap or passive valve (not illustrated).

It should be apparent that, as the rotor blade assembly 100 of FIG. 4 operates in real-world conditions and travels around the rotatable hub 18, the flow angle a at the leading edge 114 changes from a nominal angle of about 5.0 degrees+/−about 3.0 degrees—not to mention weather condition changes, etc.—and that this creates aerodynamic load variations experienced by the rotatable hub 18, and the rest of the wind turbine 10. Aerodynamic load variations increase the requirements on the bearings (not illustrated) of the rotatable hub 18 or any other load transfer region of the wind turbine 10. Further, it is well understood that the bearings are at least one limiting factor on the size/length of rotor blades in the art. It is understood by a person having ordinary skill in the art that the PAMA 402 may, in one exemplary embodiment, show an entitlement of up to about 8.0 m on an about 158.0 m rotor blade 16.

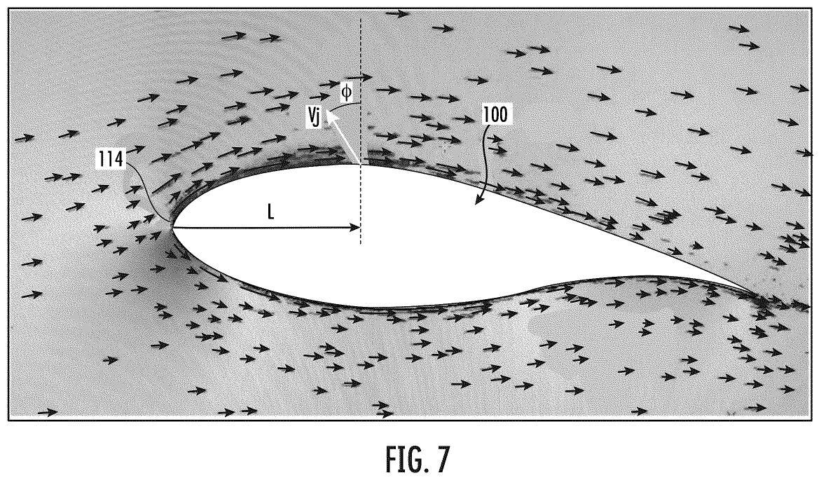

The PAMA 402 prevents rotor over-stress at the bearings—due to excessive aerodynamic load variation—without sacrificing the available hours of operation and the useful life of the wind turbine 10 and its components. The PAMA 402 decreases the aerodynamic load variations experienced by the rotatable hub 18, which in turn decreases the bearing requirements of the rotatable hub 18. In particular, the plurality of air passages 115 and the common junction 117 are place in fluid communication with the leading edge 114, the suction side surface 112, and the pressure side surface 110, and specifically tuned to allow crossflow and blow out of the PAMA 402. When the instant pressure differential of the plurality of apertures 403 passively exceeds a first tuned value, the PAMA 402 passively channels airflow from at least the leading edge (usually a high pressure point during operation) and blows it out at least on the suction side surface 112 at a first location, blow angle, and blow ratio (best seen in FIG. 7) to create a fence of air. Similarly, when the instant pressure differential of the plurality of apertures 403 passively exceeds a second tuned value, the PAMA 402 passively channels airflow from at least the leading edge 114 and jets it out at least on the pressure side surface 110 at a second location, blow angle, and blow ratio—to create a near parallel air-jet (relative to the trailing edge 116). When neither the first nor the second tuned values are exceeded, then no air feature is created. Switching between the three different states, and the two air features, is achieved in a passive fashion, and with no sensors, actuators, or motors.

As such, the PAMA 402 is configured to leverage variations in local pressure conditions about the airfoil portion 109 of the rotor blade assembly 100 to trigger variable air blowing, of different types, and from different locations along the shell 108. Further, the PAMA 402 is configured to apply fluidics to create a rotor blade that passively switches between air-jets, to spoil or augment the aerodynamic load in a manner that reduces the overall load variations experienced by the rotatable hub 18. In other exemplary embodiments, the PAMA 402 may be configured and/or tuned to passively modulate aerodynamic load variations in a desired manner to achieve a related but intended outcome during operation of the rotor blade assembly 100. In other exemplary embodiments, the PAMA 402 may be configured and/or tuned to passively modulate a variable(s) other than aerodynamic load variations, and to achieve outcomes other than preventing rotatable hub 18 over-stress at the bearings. For example, variables like the location of the air outlet, the blowing angle, and the blowing ratio (as illustrated in FIG. 7) as is understood by a person having ordinary skill in the art may be modified to achieve various desired outcomes and airflow-feature types within the acceptable blowing requirements for the particular air feature.

Further, it is understood in the art that the rotor blade assembly 100 may be configured such that it travels around the rotatable hub 18 with a flow angle at the leading edge 114 that has a different nominal angle (due to controlled pitched, for example) and that has a variance significantly greater than, or less than, the +/−about 3.0 degrees that is common in the art. A person of ordinary skill in the art understands that the PAMA 402 may be configured and tuned to complement and/or supplement any other control systems of the rotor blade assembly 100, including but not limited to any load control systems, pitch control systems, yaw control systems, spoiler control system, and augmenter control system—whether they be actively-managed or passive.

Referring now to the corresponding aerodynamic load diagram 200 of FIG. 4, the loading chart relates to the fence-of-air spoiler feature created by the PAMA 402. The loading chart illustrates the pressure differential between the plurality of apertures 403—with emphasis on the aperture on the suction side surface 112 (A in the chart) and the aperture on the leading edge 114 (B in the chart)—as a function of operating time (or the typical rotor blade revolution about the rotatable hub 18). The PAMA 402 is tuned such that the plurality of air passages 115 and the common junction 117 only allow crossflow when the pressure differential between B and A is greater than the design/tuned value. It is apparent that there is no crossflow in the PAMA 402 and, therefore, there is no air feature created along the solid curve lines for nominal values, for example. However, when the pressure gradient conditions change and the aerodynamic load experienced by the rotor blade assembly 100 causes an increase to the dashed curved, for example, then the pressure differential between B and A is large enough for the airflow to blow out of the suction side surface 112 as a fluidic spoiler.

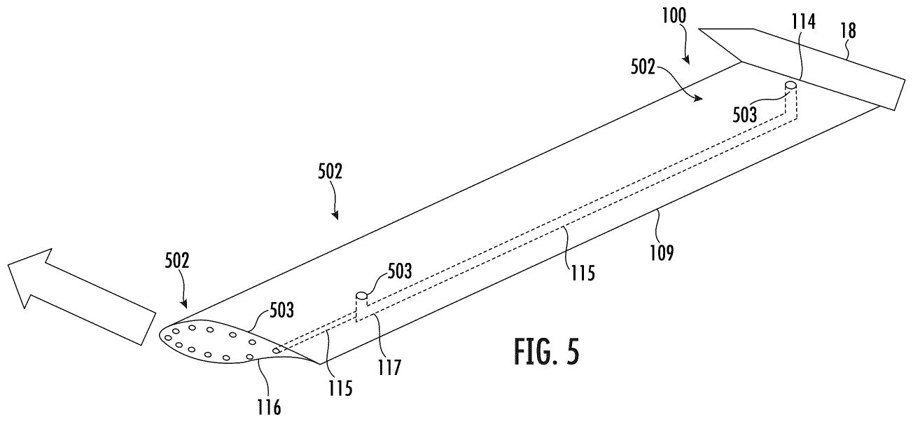

Referring now to FIG. 5, another embodiment of a rotor blade assembly 100 having a passive airflow modifying assembly 502 in accordance with the aspects of the present disclosure is illustrated. More specifically, as shown, the rotor blade 100 includes the PAMA 502. In contrast to PAMA 102 or PAMA 402 of FIGS. 1-4, however, the PAMA 502 of FIG. 5 has a plurality of apertures 503 defined by the shell 108 along the airfoil portion 109 and specifically situated on the blade tip 106 or the suction side surface 112. Each of the plurality of apertures of 503 is spaced span-wise apart along the shell 108, each in fluid communication with an internal air passage of the plurality of air passages 115 and the common junction 117 within the interior region 111. The high-pressure source comes from the lower span-wise aperture (A) and may be further augmented by radial pumping. For example, the PAMA 502 leverages radial pumping to create a higher motive pressure from one of the different, higher span-wise apertures (B, for example). The PAMA 502 also leverages radial pumping for fluidic wing-tip extension/winglet, which is especially useful for noise reduction and rotor blade assembly 100 C_{d}-value reduction.

One of ordinary skill in the art appreciates that a “lower span-wise aperture” refers to an aperture closer to the rotatable hub 18 and a “higher span-wise aperture” refers to an aperture further from the rotatable hub 18.

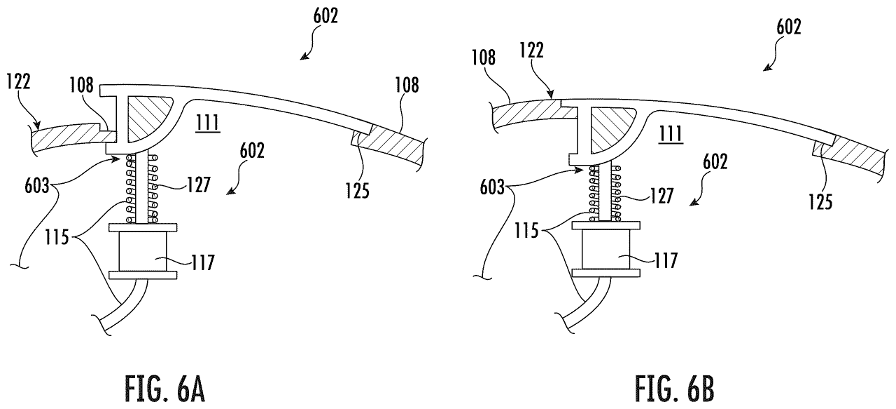

Referring now to FIGS. 6A and 6B, there is illustrated a detailed cross-sectional view of a PAMA 602 in an elevated configuration and the PAMA 602 in a retracted configuration. In contrast to PAMA 102, PAMA 402, and PAMA 502 of FIGS. 1-4, however, the PAMA 602 of FIG. 5 has: (1) a plurality of apertures 603; (2) a plurality of air passages 115 corresponding to the plurality of apertures 603; (3) a common junction 117; (4) a hinged mechanical spoiler 125; and (5) a passive spring 127 configured to hold the hinged mechanical spoiler shut—up against the shell 108—to maintain the aerodynamic airfoil portion 109, unless the pressure differential is enough to pop open the mechanical spoiler despite the spring 127 resistance. The plurality of air passages 115 and the common junction 117 are place in fluid communication with the leading edge 114, the suction side surface 112, and the pressure side surface 110, and specifically tuned to allow crossflow and blow out of the PAMA 602. When the instant pressure differential of the plurality of apertures 603 passively exceeds a first tuned value, the PAMA 602 passively channels airflow from at least the leading edge (usually a high pressure point during operation) and blows it out at least on the suction side surface 112 to lift (or not) lift the hinged mechanical spoiler 125 to separate the air flowing over the outer surface 122 of the shell 108. Switching between the two different states illustrated is achieved in a passive fashion, and with no sensors, actuators, or motors.

Referring now to FIG. 7, a cross-sectional view of another exemplary embodiment of a rotor blade assembly 100 is illustrated, particularly illustrating the instant pressure gradient about the rotor blade assembly 100. FIG. 6 is intended to illustrate what is meant by certain terminology used herein and how air outlet location and configuration can be varied. For example, an outlet may be defined by its cord length L measured from the leading edge 114 of the rotor blade assembly 100. The aperture outlet may have a blowing angle Φ and blowing ratio of Vⱼ, Vⱼ/V_{∞}, as is understood by a person of ordinary skill in the art.

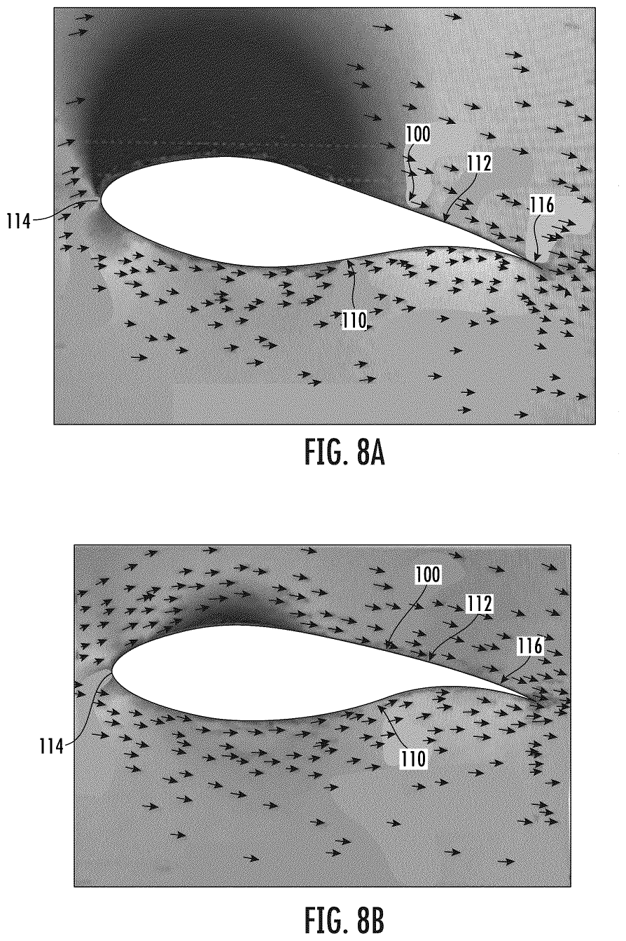

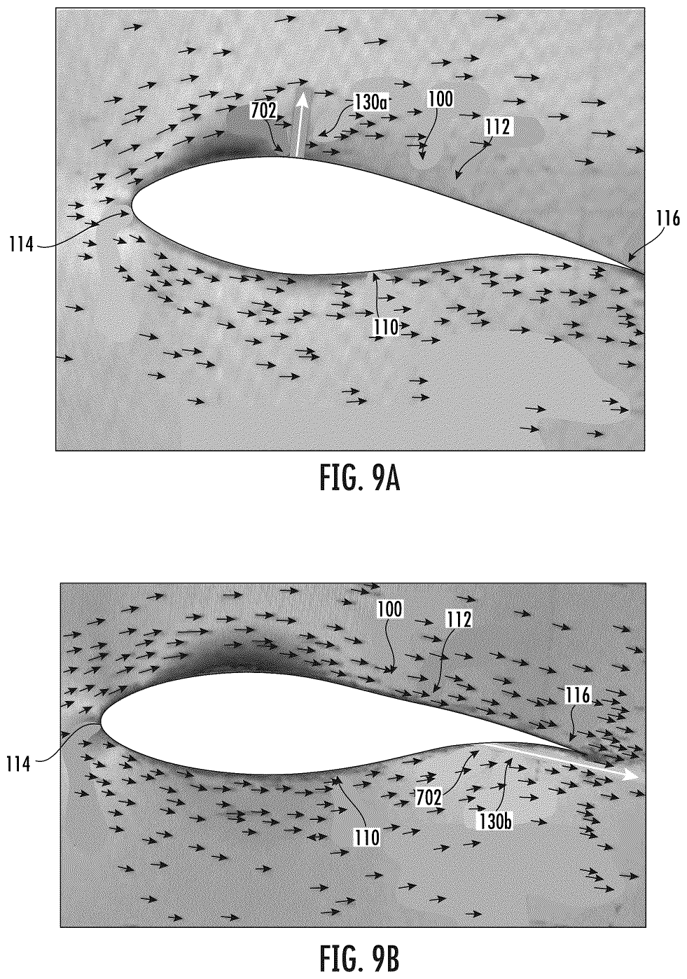

Referring now to FIG. 8A, a cross-sectional view of another exemplary embodiment of a rotor blade assembly 100 is illustrated, particularly illustrating the instant pressure gradient about the rotor blade assembly 100 as the rotor blade assembly 100 is exposed to a first flow angle. In FIG. 9A, there is illustrated a cross-sectional view of the rotor blade assembly 100 of FIG. 8A exposed to the first flow angle, but having a PAMA 702 blowing an air feature 130a out of the suction side surface 112, particularly illustrating the instant pressure gradient about the rotor blade assembly 100. Similarly, in FIG. 8B, there is illustrated a cross-sectional view of another exemplary embodiment of a rotor blade assembly 100, particularly illustrating the instant pressure gradient about the rotor blade assembly 100 as the rotor blade assembly 100 is exposed to a second flow angle. In FIG. 9B, there is illustrated a cross-sectional view of the rotor blade assembly 100 of FIG. 8B exposed to the second flow angle, also having the PAMA 702 blowing an air feature 130b out the pressure side surface 110 near the trailing edge 116, particularly illustrating the instant pressure gradient about the rotor blade assembly 100. FIGS. 8A, 8B, 9A, and 9B are intended to illustrate how the rotor blade assembly 100, including a PAMA 702, alters the pressure gradient around the rotor blade assembly 100.

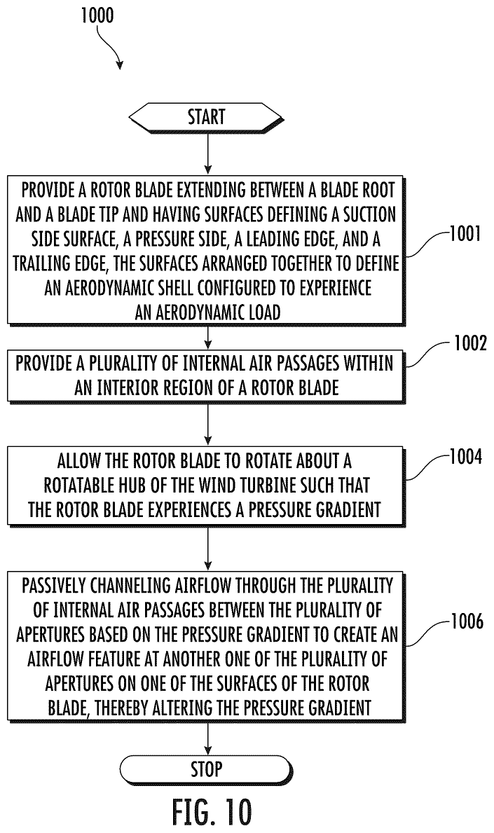

Referring now to FIG. 10, the present disclosure also is directed to a method 1000 of passively modifying a pressure gradient surrounding a rotor blade of a wind turbine, such as wind turbine 10, during operation thereof. In general, the method 1000 will be described herein with reference to the wind turbine 10 described above with reference to FIGS. 1-3. However, it should be appreciated by one of ordinary skill in the art that the disclosed method 1000 may generally be utilized with any wind turbine having any suitable configuration. In addition, although FIG. 10 depicts steps performed in a particular order for purposes of illustration and discussion, the method discussed herein is not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (1001), the method 1000 includes providing a rotor blade 100 extending between a blade root 104 and a blade tip 106 and having surfaces defining a suction side surface 112, a pressure side 110, a leading edge 114, and a trailing edge 116, the surfaces arranged together to define an aerodynamic shell 108, the aerodynamic shell 108 configured to experience an aerodynamic load. As shown at (1002), the method 1000 includes providing a plurality of internal air passages 115 within an interior region 111 of the rotor blade 100, each of the plurality of internal air passages 115 extending from a common junction 117 within the interior region 111 to one of a plurality of apertures 103 on one of the surfaces of the rotor blade 100. As shown at (1004), the method 1000 also includes allowing the rotor blade 100 to rotate about a rotatable hub 18 of the wind turbine 10 such that the rotor blade 100 experiences the pressure gradient. As shown at (1006), the method 1000 also includes passively channeling airflow through the plurality of internal air passages 115 between the plurality of apertures 103 based on the pressure gradient to create an airflow feature at another one of the plurality of apertures 103 on one of the surfaces of the rotor blade, thereby altering the pressure gradient.

In particular, (1006) may include passively channeling airflow via the plurality of internal air passages 115 from one or more of the plurality of apertures 103 on at least one of the surfaces to create the air feature from another one of the apertures 103 on at least one of the surfaces to decrease the aerodynamic load, if the pressure gradient results in an increased aerodynamic load on the rotor blade 100. Further, (1006) may include passively channeling airflow via the plurality of internal air passages 115 from one or more of the plurality of apertures 103 on at least one of the surfaces to create the air feature from another one of the apertures 103 on at least one of the surfaces to increase the aerodynamic load, if the pressure gradient results in a decreased aerodynamic load on the rotor blade 100.

This written description uses examples to disclose the disclosure, including the best mode, and to enable any person skilled in the art to practice the disclosure, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the disclosure is by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

Various aspects and embodiments of the present invention are defined by the following numbered clauses:
Clause 1. A rotor blade assembly of a wind turbine, the rotor blade assembly comprising:
a rotor blade extending between a blade root and a blade tip and having surfaces defining a suction side surface, a pressure side surface, a leading edge, and a trailing edge, the surfaces arranged together to define an aerodynamic shell, the aerodynamic shell configured to experience an aerodynamic load;
a passive airflow modifying assembly arranged between one or more of the surfaces, the passive airflow modifying assembly comprising:
a plurality of internal air passages for channeling airflow, each of the plurality of internal air passages extending from a common junction between the one or more of the surfaces to one of a plurality of apertures defined by the aerodynamic shell;
wherein the plurality of internal air passages passively channel airflow from different locations on the surfaces based on a pressure gradient around the aerodynamic shell to create an airflow feature at another location on at least one of the surfaces, thereby altering the pressure gradient.
Clause 2. The rotor blade assembly of clause 1, wherein at least one of the plurality of internal air passages extends from the common junction between the one or more of the surfaces to an aperture of the plurality of apertures adjacent to the blade root on one of the surfaces.
Clause 3. The rotor blade assembly of any of the preceding clauses, wherein at least one of the plurality of internal air passages extends from the common junction between the one or more of the surfaces to an aperture of the plurality of apertures to an aperture of the plurality of apertures on or adjacent to the blade tip of the rotor blade on one of the surfaces.
Clause 4. The rotor blade assembly of any of the preceding clauses, wherein at least one of the plurality of internal air passages extends from the common junction between the one or more of the surfaces to an aperture of the plurality of apertures on or adjacent to the leading edge.
Clause 5. The rotor blade assembly of any of the preceding clauses, wherein at least one of the plurality of internal air passages extends from the common junction between the one or more of the surfaces to an aperture of the plurality of apertures on or adjacent to the trailing edge.
Clause 6. The rotor blade assembly of any of the preceding clauses, wherein, if the pressure gradient results in an increased aerodynamic load on the rotor blade, then the plurality of internal air passages passively channel airflow from one or more of the plurality of apertures on at least one of the surfaces to create the air feature from another one of the apertures on at least one of the surfaces to decrease the aerodynamic load.
Clause 7. The rotor blade assembly of any of the preceding clauses, wherein, if the pressure gradient results in a decreased aerodynamic load on the rotor blade, then the plurality of internal air passages passively channel airflow from the one or more of the plurality of apertures on at least one of the surfaces to create the air feature from another one of the apertures on at least one of the surfaces to increase the aerodynamic load.
Clause 8. The rotor blade assembly of any of the preceding clauses, wherein the airflow feature comprises an airstream, and the airstream is an air fence or an air-jet.
Clause 9. The rotor blade assembly of any of the preceding clauses, wherein each of the plurality of apertures is configured to reversibly switch from being an air inlet to an air outlet based on a direction of the pressure gradient.
Clause 10. A wind turbine comprising:
a tower;
a nacelle mounted atop the tower;
a rotor comprising a rotatable hub coupled to the nacelle, the rotatable hub comprising at least one rotor blade assembly extending outwardly therefrom, the at least one rotor blade assembly comprising:
a rotor blade having a root portion for engaging with the rotatable hub and an airfoil portion extending from the root portion and experiencing an aerodynamic load, the root portion and the airfoil portion defining an interior region; and
a passive airflow modifying assembly within the interior region, the passive airflow modifying assembly comprising:
a plurality of internal air passages for channeling airflow, each of the plurality of internal air passages extending from a common junction within the interior region to one of a plurality of apertures defined by the airfoil portion;
wherein the plurality of internal air passages passively channel the airflow between the plurality of apertures based on a pressure gradient surrounding the rotor blade to create a variable airflow feature along the airfoil portion of the rotor blade, thereby affecting the aerodynamic load experienced by the rotor blade, and wherein each of the plurality of apertures configured to reversibly switch from being an air inlet to an air outlet based on the direction of the pressure gradient.
Clause 11. The rotor blade assembly of clause 10, wherein, if the pressure gradient results in an increased aerodynamic load on the rotor blade, then the plurality of internal air passages passively channel airflow from one or more of the plurality of apertures to create the variable air feature to decrease the aerodynamic load.
Clause 12. The rotor blade assembly of clause 11, wherein, if the pressure gradient results in a decreased aerodynamic load on the rotor blade, then the plurality of internal air passages passively channel airflow from one or more of the plurality of apertures to create the variable air feature to increase the aerodynamic load.
Clause 13. The rotor blade assembly of clauses 1012, wherein the variable airflow feature comprises an airstream, and the airstream is an air fence or an air-jet.
Clause 14. A method of passively modifying a pressure gradient surrounding a rotor blade of a wind turbine during operation thereof, the method comprising:
providing the rotor blade extending between a blade root and a blade tip and having surfaces defining a suction side surface, a pressure side, a leading edge, and a trailing edge, the surfaces arranged together to define an aerodynamic shell, the aerodynamic shell configured to experience an aerodynamic load;
providing a plurality of internal air passages within an interior region of the rotor blade, each of the plurality of internal air passages extending from a common junction within the interior region to one of a plurality of apertures on one of the surfaces of the rotor blade;
allowing the rotor blade to rotate about a rotatable hub of the wind turbine such that the rotor blade experiences a pressure gradient; and
passively channeling airflow through the plurality of internal air passages between the plurality of apertures based on the pressure gradient to create an airflow feature at another one of the plurality of apertures on one of the surfaces of the rotor blade, thereby altering the pressure gradient.
Clause 15. The method of clause 14, wherein one or more of the plurality of apertures is positioned along or adjacent to the leading edge of the airfoil portion of the rotor blade.
Clause 16. The method of clauses 14-15, wherein one or more of the plurality of apertures is positioned along or adjacent to the trailing edge of the airfoil portion of the rotor blade.
Clause 17. The method of clauses 14-16,
   wherein one or more of the plurality of apertures is situated on or adjacent to at least one of the blade tip or the blade root of the rotor blade.
Clause 18. The method of clauses 14-18, wherein, if the pressure gradient results in an increased aerodynamic load on the rotor blade, then the plurality of internal air passages passively channel airflow from one or more of the plurality of apertures on at least one of the surfaces to create the air feature from another one of the apertures on at least one of the surfaces to decrease the aerodynamic load.
Clause 19. The method of clause 18, wherein, if the pressure gradient results in a decreased aerodynamic load on the rotor blade, then the plurality of internal air passages passively channel airflow from one or more of the plurality of apertures on at least one of the surfaces to create the air feature from another one of the apertures on at least one of the surfaces to increase the aerodynamic load.
Clause 20. The method of clauses 14-19, wherein the airflow feature comprises an airstream, and the airstream is an air fence or an air-jet.

This written description uses examples to disclose the disclosure, including the best mode, and to enable any person skilled in the art to practice the disclosure, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the disclosure is by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A rotor blade assembly of a wind turbine, the rotor blade assembly comprising:
a rotor blade extending between a blade root and a blade tip and having surfaces defining a suction side surface, a pressure side, a leading edge, and a trailing edge, the surfaces arranged together to define an aerodynamic shell, the aerodynamic shell configured to experience an aerodynamic load;
a passive airflow modifying assembly arranged between one or more of the surfaces, the passive airflow modifying assembly comprising:
a plurality of internal air passages for channeling airflow, each of the plurality of internal air passages extending from a common junction between the one or more of the surfaces to one of a plurality of apertures defined by the aerodynamic shell;
wherein the plurality of internal air passages passively channel airflow from the different locations on the surfaces based on a pressure gradient around the aerodynamic shell to create an airflow feature at another location on at least one of the surfaces, thereby altering the pressure gradient.

2. The rotor blade assembly of claim 1, wherein at least one of the plurality of internal air passages extends from the common junction between the one or more of the surfaces to an aperture of the plurality of apertures adjacent to the blade root on one of the surfaces.

3. The rotor blade assembly of claim 1, wherein at least one of the plurality of internal air passages extends from the common junction between the one or more of the surfaces to an aperture of the plurality of apertures adjacent to the blade tip of the rotor blade on one of the surfaces.

4. The rotor blade assembly of claim 1, wherein at least one of the plurality of internal air passages extends from the common junction between the one or more of the surfaces to an aperture of the plurality of apertures adjacent to the leading edge.

5. The rotor blade assembly of claim 1, wherein at least one of the plurality of internal air passages extends from the common junction between the one or more of the surfaces to an aperture of the plurality of apertures adjacent to the trailing edge.

6. The rotor blade assembly of claim 1, wherein, if the pressure gradient results in an increased aerodynamic load on the rotor blade, then the plurality of internal air passages passively channel airflow from one or more of the plurality of apertures on at least one of the surfaces to create the air feature from another one of the apertures on at least one of the surfaces to decrease the aerodynamic load.

7. The rotor blade assembly of claim 1, wherein, if the pressure gradient results in a decreased aerodynamic load on the rotor blade, then the plurality of internal air passages passively channel airflow from one or more of the plurality of apertures on at least one of the surfaces to create the air feature from another one of the apertures on at least one of the surfaces to increase the aerodynamic load.

8. The rotor blade assembly of claim 7, wherein the airflow feature comprises an airstream, and the airstream is an air fence or an air-jet.

9. The rotor blade assembly of claim 1, wherein each of the plurality of apertures is configured to reversibly switch from being an air inlet to an air outlet based on a direction of the pressure gradient.

10. A wind turbine, comprising:
a tower;
a nacelle mounted atop the tower;
a rotor comprising a rotatable hub coupled to the nacelle, the rotatable hub comprising at least one rotor blade assembly extending outwardly therefrom, the at least one rotor blade assembly comprising:
a rotor blade having a root portion for engaging with the rotatable hub and an airfoil portion extending from the root portion and experiencing an aerodynamic load, the root portion and the airfoil portion defining an interior region; and
a passive airflow modifying assembly within the interior region, the passive airflow modifying assembly comprising:
a plurality of internal air passages for channeling airflow, each of the plurality of internal air passages extending from a common junction within the interior region to one of a plurality of apertures defined by the airfoil portion;
wherein the plurality of internal air passages passively channel the airflow between the plurality of apertures based on a pressure gradient surrounding the rotor blade to create a variable airflow feature along the airfoil portion of the rotor blade, thereby affecting the aerodynamic load experienced by the rotor blade, and wherein each of the plurality of apertures is configured to reversibly switch from being an air inlet to an air outlet based on a direction of the pressure gradient.

11. The rotor blade assembly of claim 10, wherein, if the pressure gradient results in an increased aerodynamic load on the rotor blade, then the plurality of internal air passages passively channel airflow from one or more of the plurality of apertures on at least one of the surfaces to create the air feature from another one of the apertures on at least one of the surfaces to decrease the aerodynamic load.

12. The rotor blade assembly of claim 11, wherein, if the pressure gradient results in a decreased aerodynamic load on the rotor blade, then the plurality of internal air passages passively channel airflow from one or more of the plurality of apertures on at least one of the surfaces to create the air feature from another one of the apertures on at least one of the surfaces to increase the aerodynamic load.

13. The rotor blade assembly of claim 12, wherein the airflow feature comprises an airstream, and the airstream is an air fence or an air-jet.

14. A method of passively modifying a pressure gradient surrounding a rotor blade of a wind turbine during operation thereof, the method comprising:
providing the rotor blade extending between a blade root and a blade tip and having surfaces defining a suction side surface, a pressure side, a leading edge, and a trailing edge, the surfaces arranged together to define an aerodynamic shell, the aerodynamic shell configured to experience an aerodynamic load;
providing a plurality of internal air passages within an interior region of the rotor blade, each of the plurality of internal air passages extending from a common junction within the interior region to one of a plurality of apertures on one of the surfaces of the rotor blade;
allowing the rotor blade to rotate about a rotatable hub of the wind turbine such that the rotor blade experiences a pressure gradient; and
passively channeling airflow through the plurality of internal air passages between the plurality of apertures based on the pressure gradient to create an airflow feature at another one of the plurality of apertures on one of the surfaces of the rotor blade, thereby altering the pressure gradient.

15. The method of claim 14, wherein one or more of the plurality of apertures is positioned along or adjacent to the leading edge of the rotor blade.

16. The method of claim 14, wherein one or more of the plurality of apertures is positioned along or adjacent to the trailing edge of the airfoil portion of the rotor blade.

17. The method of claim 14, wherein one or more of the plurality of apertures is positioned on or adjacent to at least one of the blade tip or the blade root of the rotor blade.

18. The method of claim 14, wherein, if the pressure gradient results in an increased aerodynamic load on the rotor blade, then the plurality of internal air passages passively channel airflow from one or more of the plurality of apertures on at least one of the surfaces to create the air feature from another one of the apertures on at least one of the surfaces to decrease the aerodynamic load.

19. The method of claim 18, wherein, if the pressure gradient results in a decreased aerodynamic load on the rotor blade, then the plurality of internal air passages passively channel airflow from one or more of the plurality of apertures on at least one of the surfaces to create the air feature from another one of the apertures on at least one of the surfaces to increase the aerodynamic load.

20. The method of claim 19, wherein the airflow feature comprises an airstream, and the airstream is an air fence or an air-jet.
